(19) United States
(12) Patent Application Publication
(10) Pub. No.: US 2024/0140695 A1
(43) Pub. Date: May 2, 2024

(54) INLET ASSEMBLY FOR A FILLING ASSEMBLY OF A STORAGE COMPARTMENT ASSEMBLY

(71) Applicant: CNH Industrial Canada, Ltd., Saskatoon (CA)

(72) Inventor: Jesse Blair Pidwerbesky, Warman (CA)

(21) Appl. No.: 18/493,107

(22) Filed: Oct. 24, 2023

Related U.S. Application Data
(60) Provisional application No. 63/420,799, filed on Oct. 31, 2022.

(51) Int. Cl. B65D 88/30; B65D 90/62

(52) U.S. Cl. CPC B65D 88/30; B65D 90/623; B60R 2011/0082

(57) ABSTRACT

An inlet assembly for a filling assembly of a storage compartment assembly includes a hopper configured to receive particulate material. The inlet assembly also includes a fill tray movably coupled to the hopper and configured to move between a stowage position and a loading position. One of the fill tray or the hopper has a slot, and the other of the fill tray or the hopper has a pivot engaged with the slot. Furthermore, the hopper has a first engagement feature, and the fill tray has a second engagement feature. In addition, the pivot and the slot enable the fill tray to move from the stowage position to a transitional position to align the first and second engagement features, and the pivot and the slot enable the fill tray to move from the transitional position to the loading position to engage the first and second engagement features.

### CROSS-REFERENCE TO RELATED APPLICATION

This application claims priority from and the benefit of U.S. Provisional Application Ser. No. 63/420,799, entitled “INLET ASSEMBLY FOR A FILLING ASSEMBLY OF A STORAGE COMPARTMENT ASSEMBLY”, filed Oct. 31, 2022, which is hereby incorporated by reference in its entirety.

### BACKGROUND

The present disclosure relates generally to an inlet assembly for a filling assembly of a storage compartment assembly.

Generally, agricultural implements are towed behind a work vehicle, such as a tractor. The agricultural implement may include multiple rows of ground engaging opener assemblies to excavate trenches into soil for depositing a particulate material, such as seeds or fertilizer. An air cart may be towed behind or in front of the agricultural implement and configured to provide the particulate material to the ground engaging opener assemblies. In this manner, rows of the particulate material may be deposited into the soil. Some particulate material (e.g., wheat seeds, fertilizer, etc.) may be deposited into the soil in large quantities. Accordingly, the particulate material may be stored in a larger primary storage compartment. Further, some particulate material (e.g., canola seed, inoculants, etc.) may be deposited into the soil in small quantities. Accordingly, such particulate material may be stored in a smaller auxiliary storage compartment of the air cart.

Each primary storage compartment may include a tapered portion configured to direct the particulate material to a respective metering system. Each metering system, in turn, controls flow of the particulate material to the ground engaging opener assemblies of the agricultural implement. The auxiliary storage compartment may be positioned within a space between the tapered portions of adjacent primary storage compartments to efficiently utilize the available space within the air cart. However, positioning the auxiliary storage compartment between the tapered portions of adjacent primary storage compartments blocks access to the top of the auxiliary storage compartment. Accordingly, the auxiliary storage compartment may not be loaded from the top. Moreover, loading the auxiliary storage compartment from the side may cause the particulate material to be unevenly distributed within the auxiliary storage compartment. As a result, portions of a metering system positioned below the auxiliary storage compartment may not receive the particulate material, thereby causing the particulate material to be unevenly distributed throughout the field.

### BRIEF DESCRIPTION

In certain embodiments, an inlet assembly for a filling assembly of a storage compartment assembly includes a hopper configured to receive particulate material. The inlet assembly also includes a fill tray movably coupled to the hopper and configured to move between a stowage position and a loading position. One of the fill tray or the hopper has a slot, and the other of the fill tray or the hopper has a pivot engaged with the slot. Furthermore, the hopper has a first engagement feature, and the fill tray has a second engagement feature configured to engage the first engagement feature to block rotation of the fill tray about the pivot. In addition, the pivot and the slot enable the fill tray to move from the stowage position to a transitional position to align the first and second engagement features, and the pivot and the slot enable the fill tray to move from the transitional position to the loading position to engage the first and second engagement features.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having an agricultural implement and an air cart;

FIG. 2 is a perspective view of an embodiment of an auxiliary storage compartment assembly and an embodiment of a metering system that may be employed within the air cart of FIG. 1;

FIG. 3 is a side view of an inlet assembly of a filling assembly of the auxiliary storage compartment assembly of FIG. 2, in which the inlet assembly is in a first loading configuration;

FIG. 4 is a perspective view of a portion of the inlet assembly of FIG. 3;

FIG. 5 is a perspective view of the inlet assembly of FIG. 3, in which the inlet assembly is in a second loading configuration; and

FIG. 6 is a perspective view of a portion of the inlet assembly of FIG. 3, in which the inlet assembly is in an operation configuration.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

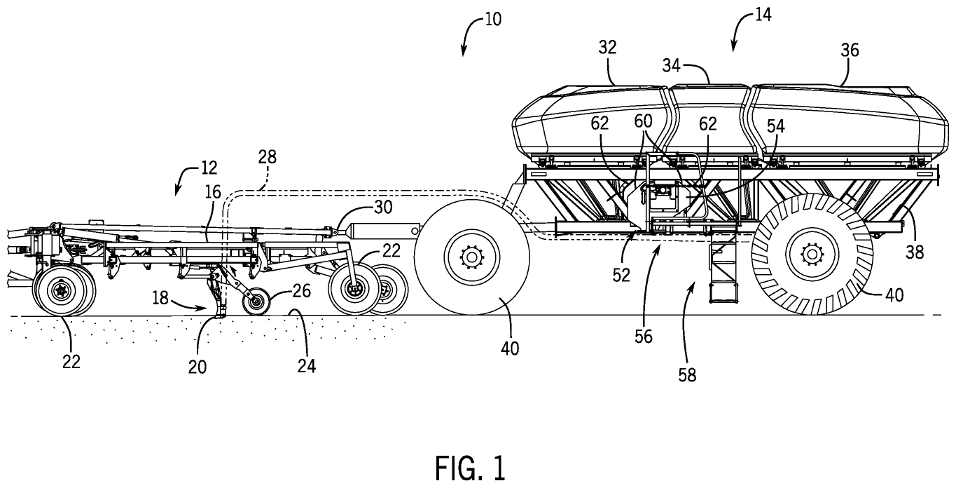

FIG. 1 is a side view of an embodiment of an agricultural system 10 having an agricultural implement 12 and an air cart 14. In the illustrated embodiment, the agricultural implement 12 includes a tool frame 16, and a row unit 18, which includes an opener 20, is coupled to the tool frame 16. As illustrated, wheel assemblies 22 are also coupled to the tool frame 16. The agricultural implement 12 may be pulled through a field by a work vehicle (e.g., a tractor), and the agricultural implement 12 may deposit rows of particulate material (e.g., seed, fertilizer, inoculant, etc.) into the soil as the agricultural implement 12 traverses the field. The wheel assemblies 22 contact the soil surface and enable the agricultural implement 12 to be pulled by the work vehicle, and the row unit 18 may deposit one row of the particulate material into the soil. Although only one row unit 18 is shown coupled to the tool frame 16 for clarity, the agricultural implement 12 may include multiple row units 18 (e.g., organized in one or more rows across the agricultural implement 12). In some embodiments, the agricultural implement 12 may include 12, 14, 16, 18, 20, or more row units 18, each of which may deposit particulate material into the soil to form a respective row.

To facilitate depositing the particulate material within the soil, each row unit 18 includes the opener 20. In response to movement of the row unit 18 through the field, the opener 20 exerts a force onto the soil 24, thereby excavating a trench within the soil 24. As the agricultural implement 12 moves through the field, the row unit 18 may deposit the particulate material into the excavated trench (e.g., via a seed tube). Then, a press wheel 26 of the row unit 18 may pack soil onto the deposited particulate material.

In the illustrated embodiment, the air cart 14 pneumatically distributes the particulate material to the row unit 18 via distribution hose(s) 28. The air cart 14 may include metering system(s) configured to control particulate material flow rate(s) to the distribution hose(s) 28, and an air source may provide an airflow through the distribution hose(s) 28. The airflow may interact with the particulate material flowing into each distribution hose 28 from a respective metering system, thereby fluidizing the particulate material and forming an air/particulate material mixture. Each distribution hose 28 is configured to transport the air/particulate material mixture to at least one row unit 18, thereby providing the row unit(s) with a metered flow of the particulate material. The air cart 14 may supply particulate material to multiple row units 18 (e.g., via one or more distribution hoses 28). As such, the metering system(s) of the air cart 14, each of which is coupled to one or more distribution hoses 28, may control the particulate material flow rate to multiple row units 18.

In the illustrated embodiment, the air cart 14 is towed behind the agricultural implement 12. For example, the agricultural implement 12 may be coupled to the work vehicle by a first hitch assembly, and the air cart 14 may be coupled to the agricultural implement 12 by a second hitch assembly 30. However, in other embodiments, the agricultural implement 12 may be towed behind the air cart 14. In further embodiments, the agricultural implement and the air cart may be part of a single unit that is towed behind a work vehicle, or the implement and the air cart may be elements of a self-propelled vehicle.

The air cart 14 may centrally store the particulate material (e.g., seeds) and distribute the particulate material (e.g., seeds) to the row units. In the illustrated embodiment, the air cart 14 includes three primary storage compartments 32, 34, and 36, a frame 38, and wheels 40. Further, the air cart 14 includes an auxiliary storage compartment assembly 52 having an auxiliary storage compartment 54. The towing hitch 30 couples the tool frame 16 of the agricultural implement 12 to the air cart frame 38, which enables the air cart 14 to be towed with the agricultural implement 12. In addition, the auxiliary storage compartment assembly 52 includes a filling assembly 56 coupled to the auxiliary storage compartment 54 and configured to direct particulate material into the auxiliary storage compartment. The auxiliary storage compartment assembly 52 also includes a platform assembly 58 positioned adjacent to the auxiliary storage compartment 54. The platform assembly 58 includes a platform configured to support an operator, thereby enabling the operator to load the particulate material into the filling assembly 56.

The primary storage compartments 32, 34, and 36, and the auxiliary storage compartment 54 may centrally store the particulate material (e.g., seeds, granular fertilizer, granular inoculant, etc.). In certain embodiments, the primary storage compartments 32, 34, and 36 may each store a different particulate material. For example, the first primary storage compartment 32 may store legume seeds, and the second primary storage compartment 34 may store a dry fertilizer. Additionally, in this example, the auxiliary storage compartment 54 may store granular inoculant, which is deposited into the soil in conjunction with the legume seeds and the dry fertilizer. The air cart 14 may deliver the seeds, fertilizer, and inoculant to the agricultural implement 12 via separate distribution hoses (e.g., three distribution hoses per row unit, three distribution hoses per header that supplies the particulate material to respective row units, etc.), or as a mixture through a single distribution hose (e.g., one distribution hose per row unit, one distribution hose per header that supplies the particulate material to respective row units, etc.). A metering system is disposed below each storage compartment, and the metering system is configured to control the flow of the respective particulate material into the respective distribution hose(s).

Further, as illustrated, the auxiliary storage compartment 54 is positioned beneath a portion of the first primary storage compartment 32 and a portion of the second primary storage compartment 34, and the auxiliary storage compartment 54 may include storage for more than 15 bushels (e.g., 529 liters) of particulate material. To improve storage capacity of the auxiliary storage compartment 54, upper walls 60 of the auxiliary storage compartment 54 have slopes that substantially correspond to respective slopes of bottom portions 62 of the first and second primary storage compartments 32 and 34. Therefore, the shape of the auxiliary storage compartment 54 enables the auxiliary storage compartment 54 to utilize a substantial portion of the space between the first and second primary storage compartments 32 and 34. In other embodiments, the auxiliary storage compartment may be positioned between the second and third primary storage compartments. Furthermore, in certain embodiments, the auxiliary storage compartment 54 may have another suitable shape.

In the illustrated embodiment, the auxiliary storage compartment 54 has an opening in a lateral side of the auxiliary storage compartment 54. The opening is configured to receive the particulate material from the filling assembly 56. In addition, the filling assembly 56 is coupled to the auxiliary storage compartment 54 (e.g., to the lateral side of the auxiliary storage compartment), and the filling assembly 56 has an inlet and an outlet. The outlet is aligned with the opening of the auxiliary storage compartment 54, and the filling assembly 56 establishes a flow path that extends downwardly and laterally inwardly (e.g., laterally toward the auxiliary storage compartment 54) from the inlet to the outlet. Furthermore, in certain embodiments, the auxiliary storage compartment assembly 52 includes a conveyor assembly having a rotary conveyor. The rotary conveyor extends through a portion of the filling assembly and through a portion of the auxiliary storage compartment 54. The rotary conveyor is configured to move the particulate material laterally through the portion of the filling assembly and through the portion of the auxiliary storage compartment in response to rotation of the rotary conveyor. Accordingly, the filling assembly 56 and the conveyor assembly cooperate to substantially evenly distribute the particulate material along a lateral axis within the auxiliary storage compartment. As a result, the respective metering system may receive a substantially uniform supply of the particulate material from the auxiliary storage compartment 54 during operation of the respective metering system.

As discussed in detail below, the filling assembly 56 includes an inlet assembly, and the inlet assembly includes a hopper configured to receive the particulate material (e.g., the inlet of the filling assembly is formed at the hopper). In addition, the inlet assembly includes a fill tray movably coupled to the hopper and configured to move between a stowage position and a loading position. One of the fill tray or the hopper has a slot, and the other of the fill tray or the hopper has a pivot engaged with the slot. Furthermore, the hopper has a first engagement feature, and the fill tray has a second engagement feature configured to engage the first engagement feature to block rotation of the fill tray about the pivot. The pivot and the slot enable the fill tray to move from the operation position to a transitional position to align the first and second engagement features, and the pivot and the slot enable the fill tray to move from the transitional position to the loading position to engage the first and second engagement features. The fill tray is configured to direct the particulate material into the hopper while the fill tray is in the loading position. Accordingly, the fill tray enables the particulate material to be poured/deposited at a position laterally outward from the hopper, thereby enabling equipment supporting the particulate material (e.g., forklift) to be positioned farther from the storage compartments of the air cart. In addition, while the fill tray is in the stowage position, the lateral extent and the vertical extent of the filling assembly 56 may be reduced.

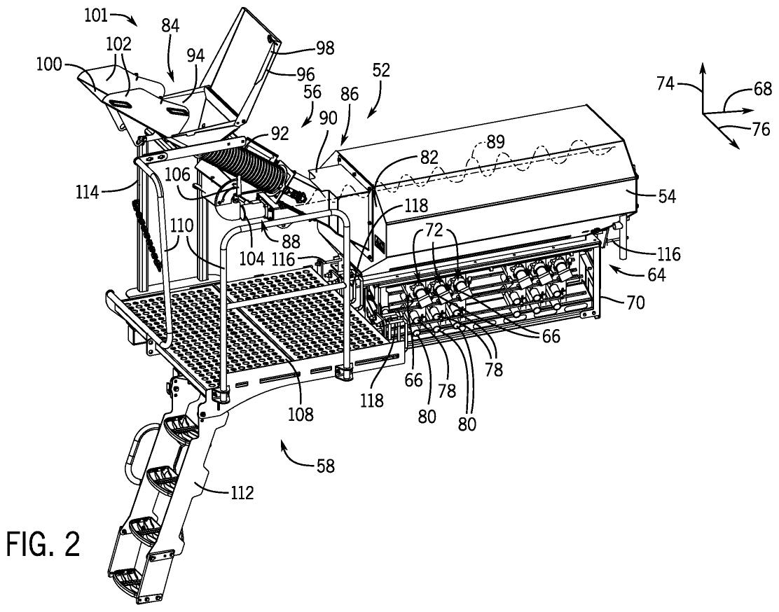

FIG. 2 is a perspective view of an embodiment of an auxiliary storage compartment assembly 52 and an embodiment of a metering system 64 that may be employed within the air cart of FIG. 1. The auxiliary storage compartment 54 is configured to store particulate material and to provide the particulate material to the metering system 64. In the illustrated embodiment, the metering system 64 includes multiple seed meters 66 distributed along a lateral axis 68 of the auxiliary storage compartment assembly 52, in which the seed meters 66 are supported by a frame 70. While the illustrated metering system 64 includes six seed meters 66, in other embodiments, the metering system may include 1, 2, 4, 8, 10, 12, 14, or more seed meters. In the illustrated embodiment, each seed meter 66 includes at least one respective metering device 72 (e.g., meter roller) to control flow of particulate material to a respective conduit (e.g., distribution hose), which may provide the particulate material to a row unit or a header that distributes the particulate material to multiple row units. Each seed meter 66 also includes an inlet configured to receive the particulate material from the auxiliary storage compartment 54 (e.g., along a vertical axis 74). Each inlet extends along the lateral axis 68 and along a longitudinal axis 76.

Furthermore, each seed meter 66 includes a first conduit connector 78 and a second conduit connector 80. Each conduit connector 78, 80 is configured to receive airflow from the air source and the particulate material from the respective metering device 72, thereby producing the air/particulate material mixture, which flows to the row unit(s). First conduits (e.g., distribution hoses) may be coupled to the first conduit connectors 78, and second conduits (e.g., distribution hoses) may be coupled to the second conduit connectors 80. Furthermore, each seed meter 66 may include a gate that enables selection of the first conduit connector 78 or the second conduit connector 80. Once the first conduit connector 78 or the second conduit connector 80 is selected, the particulate material flows through the selected conduit connector 78, 80 to the respective conduit (e.g., distribution hose) to the row unit(s).

In the illustrated embodiment, the auxiliary storage compartment 54 has an opening in a lateral side 82 of the auxiliary storage compartment 54. The opening is configured to receive particulate material from the filling assembly 56. Furthermore, the filling assembly 56 is coupled to the lateral side 82 of the auxiliary storage compartment 54, and the filling assembly 56 has an inlet 84 and an outlet 86. The outlet 86 is aligned with the opening of the auxiliary storage compartment 54, and the filling assembly 56 establishes a flow path that extends downwardly (e.g., along the vertical axis 74) and laterally inwardly (e.g., toward the auxiliary storage compartment along the lateral axis 68) from the inlet 84 to the outlet 86. While the filling assembly 56 is coupled to the lateral side 82 of the auxiliary storage compartment 54 in the illustrated embodiment, in other embodiments, the filling assembly may be coupled to other suitable portion(s) of the auxiliary storage compartment (e.g., alone or in combination with the lateral side).

In addition, the auxiliary storage compartment assembly 52 includes a conveyor assembly 88 having a rotary conveyor 89. The rotary conveyor 89 extends through a portion of the filling assembly 56 and a portion of the auxiliary storage compartment 54, and the rotary conveyor 89 is configured to move the particulate material laterally (e.g., along the lateral axis 68) through the portion of the filling assembly 56 and through the portion of the auxiliary storage compartment 54 in response to rotation of the rotary conveyor 89. Accordingly, the filling assembly 56 and the conveyor assembly 88 cooperate to substantially evenly distribute the particulate material along the lateral axis 68 within the auxiliary storage compartment 54. As a result, the metering system 64 may receive a substantially uniform supply of the particulate material from the auxiliary storage compartment 54 during operation of the metering system 64.

In the illustrated embodiment, the filling assembly 56 includes a fill chute 90, a fill tube 92, and a hopper 94. As illustrated, the fill chute 90 is coupled to the lateral side 82 of the auxiliary storage compartment 54. In the illustrated embodiment, the fill chute 90 is coupled to the auxiliary storage compartment 54 by a fastener connection. However, in other embodiments, the fill chute may be coupled to the auxiliary storage compartment by any other suitable type(s) of connection(s) (e.g., alone or in combination with the fastener connection), such as a welded connection, an adhesive connection, a press-fit connection, other suitable type(s) of connection(s), or a combination thereof. In addition, the outlet 86 of the filling assembly 56 is formed at the fill chute 90, the inlet 84 of the filling assembly 56 is formed at the hopper 94, and the fill tube 92 is positioned between the hopper 94 and the fill chute 90. Accordingly, the operator may pour particulate material (e.g., from a bag, etc.) into the hopper 94 (e.g., which is configured to receive the particulate material), and due to the downward and laterally inward direction of the flow path established by the filling assembly 56, the particulate material flows through the hopper 94, the fill tube 92, and the fill chute 90 into the auxiliary storage compartment 54 under the influence of gravity.

In the illustrated embodiment, the hopper 94 orients the inlet 84 of the filling assembly 56 within a plane formed by the lateral axis 68 and the longitudinal axis 76 (e.g., perpendicular to the vertical axis 74, parallel to the soil surface), thereby facilitating deposition of the particulate material within the filling assembly 56. However, in other embodiments, the inlet of the filling assembly may be oriented at any suitable angle(s) relative to the plane formed by the lateral axis and the longitudinal axis. Furthermore, in the illustrated embodiment, the fill tube 92 includes a flexible hose. While the fill tube 92 includes a single flexible hose in the illustrated embodiment, in other embodiments, the fill tube may include other/additional suitable type(s) of conduit(s) (e.g., one or more substantially rigid conduits, multiple flexible hoses, etc.). In addition, the fill tube 92 has a substantially circular cross-sectional shape in the illustrated embodiment. However, in other embodiments, the fill tube may have any other suitable cross-sectional shape (e.g., polygonal, elliptical, etc.). Furthermore, the fill chute 90 has a square cross-sectional shape in the illustrated embodiment. However, in other embodiments, the fill chute may have any other suitable cross-sectional shape.

In the illustrated embodiment, the filling assembly 56 includes a lid 96 configured to selectively block the inlet 84 of the filling assembly 56. The lid 96 may be transitioned to the illustrated open position to enable particulate material to enter the filling assembly 56 (e.g., the hopper 94 of the filling assembly 56), and the lid 96 may be transitioned to a closed position to block particulate material from entering the filling assembly 56 (e.g., the hopper 94 of the filling assembly 56). The lid 96 may be transitioned to the illustrated open position during loading operations, and the lid 96 may be transitioned to the closed position to block dirt and/or debris from entering the filling assembly 56. In the illustrated embodiment, the lid 96 is pivotally coupled to the hopper 94, thereby enabling the lid 96 to pivot between the open and closed positions. In the illustrated embodiment, rotation of the lid 96 away from the inlet 84 is blocked while the lid 96 is in the open position, thereby establishing an angled lid surface extending toward the inlet 84. Accordingly, the lid may direct particulate material toward the inlet 84 while the lid 96 is in the illustrated open position. Furthermore, in the illustrated embodiment, the lid 96 includes a tab 98 configured to facilitate pivoting the lid 96 between the open and closed positions. However, in other embodiments, the tab may be omitted and/or the lid may include other suitable feature(s) to facilitate pivoting the lid between the open and closed positions (e.g., a handle, a motor, etc.). While the lid 96 is configured to pivot between the open and closed positions in the illustrated embodiment, in other embodiments, the lid may be slidably coupled to the hopper, or the lid may be removably coupled to the hopper. Furthermore, while the filling assembly 56 includes the lid 96 in the illustrated embodiment, in other embodiments, the lid may be omitted.

In the illustrated embodiment, the filling assembly 56 includes a fill tray 100 configured to direct the particulate material toward the inlet 84 of the filling assembly 56. The fill tray 100 is an element of an inlet assembly 101 of the filling assembly 56, which also includes the hopper 94 and the lid 96. As illustrated, the fill tray 100 includes side plates 102 configured to block movement of the particulate material along the longitudinal axis 76. Furthermore, in the illustrated embodiment, the fill tray 100 is configured to move between the illustrated loading position and a stowage position. In the illustrated embodiment, the fill tray 100 is positioned on an opposite lateral side of the hopper 94 from the auxiliary storage compartment 54 (e.g., opposite side along the lateral axis 68). Accordingly, the fill tray 100 enables the particulate material to be poured/deposited at a position laterally outward from the hopper 94 (e.g., outward from the hopper 94 along the lateral axis 68), thereby enabling equipment supporting the particulate material (e.g., forklift) to be positioned farther from the storage compartments of the air cart. In addition, while the fill tray 100 is in the stowage position, the lateral extent (e.g., extent along the lateral axis 68) and the vertical extent (e.g., extent along the vertical axis 74) of the filling assembly 56 may be reduced.

As discussed in detail below, one of the fill tray 100 or the hopper 94 has a slot, and the other of the fill tray 100 or the hopper 94 has a pivot engaged with the slot. Furthermore, the hopper 94 has a first engagement feature, and the fill tray 100 has a second engagement feature configured to engage the first engagement feature to block rotation of the fill tray 100 about the pivot. In addition, the pivot and the slot enable the fill tray to move from the stowage position to a transitional position to align the first and second engagement features, and the pivot and the slot enable the fill tray to move from the transitional position to the loading position to engage the first and second engagement features. Accordingly, while the fill tray 100 is in the loading position, the pivot supports the weight of the fill tray 100 and the particulate material within the fill tray, and the first and second engagement features block rotation of the fill tray 100 about the pivot. As a result, the fill tray 100 may support a substantial weight of particulate material while in the loading position. In addition, the pivot and the slot enable the fill tray to move from the loading position to the transitional position via application of a small force (e.g., a significantly smaller force than the weight of the particulate material within the fill tray during loading operations). As such, the fill tray 100 may be readily moved from the loading position to the transitional position and from the transitional position to the stowage position.

In the illustrated embodiment, the conveyor assembly 88 includes a motor assembly 104 configured to drive the rotary conveyor 89 in rotation. The motor assembly 104 may include any suitable type(s) of motor(s), such as a hydraulic motor, an electric motor, or a pneumatic motor. Furthermore, the motor assembly 104 may include a transmission, a clutch, a gear assembly, other suitable component(s), or a combination thereof. In the illustrated embodiment, the motor assembly 104 is coupled to the fill chute 90, and an opening in the fill chute 90 facilitates passage of a portion of the motor assembly 104 into an interior of the fill chute 90. Coupling the motor assembly 104 to the fill chute 90 may reduce the overall size/dimensions of the auxiliary storage compartment assembly 52 (e.g., as compared to a motor assembly positioned on an opposite lateral side of the auxiliary storage compartment from the filling assembly). While the motor assembly 104 is coupled to the fill chute 90 in the illustrated embodiment, in other embodiments, the motor assembly may be coupled to another suitable component of the filling assembly, the platform assembly, or the auxiliary storage compartment. In the illustrated embodiment, the conveyor assembly 88 includes a speed controller 106 communicatively coupled (e.g., fluidly coupled, electrically coupled, etc.) to the motor assembly 104 and configured to control a rotation speed of the rotary conveyor 89. For example, the speed controller may control a flow rate of fluid to a hydraulic or pneumatic motor of the motor assembly, or the speed controller may control electrical power output to an electric motor of the motor assembly. The speed controller 106 includes a handle in the illustrated embodiment. However, in other embodiments, the speed controller may include a knob, a switch, or any other suitable controller. Furthermore, in certain embodiments, the speed controller may be omitted.

As previously discussed, the auxiliary storage compartment assembly 52 includes a platform assembly 58 positioned adjacent to the auxiliary storage compartment 54. The platform assembly 58 includes a platform 108 configured to support an operator, thereby enabling the operator to load/pour the particulate material (e.g., from a bag, etc.) into the filling assembly 56. In the illustrated embodiment, the platform assembly 58 includes railings 110 configured to block movement of the operator away from the platform 108 and to provide handholds for the operator. However, in other embodiments, at least a portion of the railings (e.g., all of the railings) may be omitted. Furthermore, in the illustrated embodiment, the platform assembly 58 includes a ladder 112 coupled to the platform 108. The ladder 112 is configured to facilitate access to the platform 108. In the illustrated embodiment, the ladder 112 is configured to rotate from the illustrated loading position to a stowage position. The ladder 112 may rotate upwardly about the longitudinal axis 76 from the illustrated loading position to the stowage position, thereby substantially reducing or eliminating the possibility of the ladder 112 engaging the soil surface while the air cart is moving through the agricultural field. In certain embodiments, the platform assembly 58 includes a locking mechanism configured to block rotation of the ladder 112 while the ladder is in the loading position and while the ladder is in the stowage position. For example, the locking mechanism may include a pin, a latch, a fastener, another suitable component, or a combination thereof. In addition, while the ladder is configured to pivot between the loading position and the stowage position in the illustrated embodiment, in other embodiments, the ladder may be configured to translate between the loading and stowage positions, or the ladder may be fixed to the platform. While the platform assembly 58 includes the ladder 112 in the illustrated embodiment, in other embodiments, the ladder may be omitted.

In the illustrated embodiment, the platform assembly 58 includes a support frame 114 coupled to the platform 108 and configured to support the hopper 94. For example, the support frame may be coupled to the hopper 94 via any suitable type(s) of connection(s), such as a fastener connection, a welded connection, an adhesive connection, other suitable type(s) of connection(s), or a combination thereof. The support frame 114 may include any suitable number and/or configuration of support elements (e.g., including tube(s), rod(s), bar(s), etc.). In the illustrated embodiment, the speed controller 106 is coupled to the support frame 114 and configured to be positioned proximate to the operator while the operator is on the platform 108, thereby facilitating operator control of the rotation speed of the rotary conveyor 89. However, in other embodiments, the speed controller may be coupled to any suitable component of the auxiliary storage compartment assembly.

In the illustrated embodiment, the auxiliary storage compartment assembly 52 includes auxiliary storage compartment mounts 116 configured to couple the auxiliary storage compartment 54 to the frame of the air cart. In addition, the auxiliary storage compartment assembly 52 includes platform mounts 118 configured to couple the platform 108 to the frame of the air cart. The auxiliary storage compartment mounts 116 are separate from the platform mounts 118. Accordingly, the platform 108 mounts to the frame of the air cart independently of the auxiliary storage compartment 54. In addition, the other components of the platform assembly 58 are coupled to the frame of the air cart via the platform 108. As such, the entire platform assembly 58 is supported by the frame of the air cart, and the platform assembly 58 is coupled to the frame of the air cart independently of the auxiliary storage compartment 54. In certain embodiments, at least one component of the platform assembly, other than the platform, may be mounted to the frame of the air cart independently of the auxiliary storage compartment (e.g., in addition to or as an alternative to the coupling between the platform and the air cart frame). Because the auxiliary storage compartment is mounted to the frame of the air cart independently of the platform assembly, weight sensor(s) (e.g., strain gauge(s), load cell(s), etc.) may be used to monitor the weight of the auxiliary storage compartment (e.g., after loading, during operation of the metering system, etc.) without interference from the platform assembly. While the auxiliary storage compartment 54 and the platform assembly 58 are coupled to the air cart frame with mounts in the illustrated embodiment, in other embodiments, at least one of the auxiliary storage compartment or the platform assembly may be coupled to the air cart frame by other/additional suitable connection(s) (e.g., including a fastener connection, a welded connection, an adhesive connection, etc.). Furthermore, while the platform assembly 58 is coupled to the frame of the air cart independently of the auxiliary storage compartment 54 in the illustrated embodiment, in other embodiments, the auxiliary storage compartment may be coupled to the air cart frame via the platform assembly, or the platform assembly may be coupled to the air cart frame via the auxiliary storage compartment. In addition, while the auxiliary storage compartment assembly 52 includes the platform assembly 58 in the illustrated embodiment, in other embodiments, the platform assembly may be omitted.

While the storage compartment assembly 52 includes the conveyor assembly 88 in the illustrated embodiment, in other embodiments, the conveyor assembly may be omitted. Furthermore, in certain embodiments, the fill chute and/or the fill tube may be omitted. For example, the hopper may be directly coupled to the auxiliary storage compartment, or the hopper may be integrally formed with the auxiliary storage compartment. Furthermore, while the inlet assembly 101 is disclosed herein with regard to a filling assembly 56 for an auxiliary storage compartment assembly 52, in certain embodiments, the inlet assembly may be employed within another suitable storage compartment assembly (e.g., on an air cart or on another suitable machine).

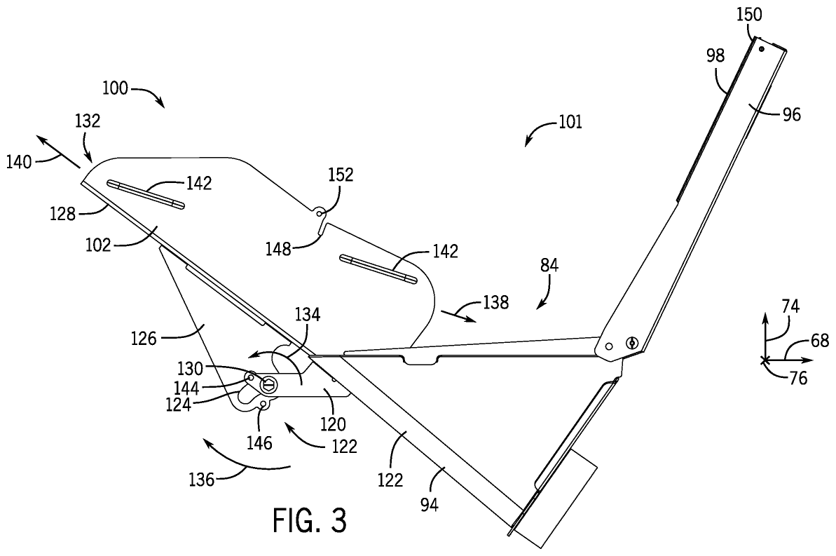

FIG. 3 is a side view of the inlet assembly 101 of the filling assembly of the auxiliary storage compartment assembly of FIG. 2, in which the inlet assembly 101 is in a first loading configuration. As previously discussed, the hopper 94 is configured to receive particulate material at the inlet 84, and the fill tray 100 is configured to direct the particulate material toward the inlet 84. In addition, the fill tray 100 is movably coupled to the hopper 94 and configured to move between a stowage position and the illustrated loading position. While the inlet assembly 101 is in the illustrated first loading configuration, the fill tray 100 is in the loading position, and the lid 96 is in the illustrated open position. Accordingly, particulate material poured/deposited onto the fill tray 100 flows down the fill tray 100 into the hopper 94 along the vertical and lateral axes.

In the illustrated embodiment, the hopper 94 includes two supports 120 configured to support the fill tray 100. Each support 120 may be coupled to a body 122 of the hopper 94 via any suitable type(s) of connection(s), such as a welded connection, a fastener connection, a press-fit connection, an adhesive connection, other suitable type(s) of connection(s), or a combination thereof. While the hopper 94 includes two supports 120 in the illustrated embodiment, in other embodiments, the hopper may include more or fewer supports (e.g., 1, 3, 4, or more).

In the illustrated embodiment, each support 120 includes a respective pivot 122, and each pivot 122 is engaged with a corresponding slot 124 of the fill tray 100. Each slot 124 is formed within a respective rib 126 of the fill tray 100. The ribs 126 are configured to enhance the rigidity of the fill tray 100, and each rib 126 may be coupled to a base 128 of the fill tray 100 via any suitable type(s) of connection(s), such as a welded connection, a fastener connection, a press-fit connection, an adhesive connection, other suitable type(s) of connection(s), or a combination thereof. While the slots 124 are formed within the ribs 126 in the illustrated embodiment, in other embodiments, at least one slot may be formed within any other suitable element of the fill tray. In the illustrated embodiment, each pivot 122 includes a respective bolt 130. The bolts 130 may couple the fill tray 100 to the hopper 94 via respective nuts engaged with the bolts. While the pivots 122 include bolts 130 in the illustrated embodiment, in other embodiments, at least one pivot may include another suitable type of pivot device, such as a pin or a shaft. In such embodiments, the pivot device(s) may couple the fill tray to the hopper via fastening element(s) (e.g., cotter pin(s), clip(s), etc.) engaged with the respective pivot device(s). Furthermore, in certain embodiments, at least one pivot may be integrally formed with the respective support, and the pivot may couple the fill tray to the hopper via fastening element(s) (e.g., cotter pin(s), clip(s), etc.) engaged with the pivot. In addition, while the pivots are positioned at the supports in the illustrated embodiment, in other embodiments, at least one pivot (e.g., all of the pivots) may be positioned at other suitable element(s) of the hopper (e.g., the body). In such embodiments, the respective support(s) may be omitted.

As discussed in detail below, the hopper 94 has a first engagement feature, and the fill tray 100 has a second engagement feature. The second engagement feature is configured to engage the first engagement feature to block rotation of the fill tray 100 about the pivots 122. As particulate material is poured/disposed on an end portion 132 of the fill tray 100, the pivots 122 support the weight of the fill tray 100 and the particulate material within the fill tray 100. In addition, the particulate material being poured/disposed on the end portion 132 of the fill tray 100 urges the fill tray 100 to rotate about the pivots 122 in a first rotational direction 134. However, engagement of the first and second engagement features with one another blocks rotation of the fill tray 100 about the pivots 122 in the first rotational direction 134. In addition, contact between the base 128 of the fill tray 100 and the body 122 of the hopper 94 blocks rotation of the fill tray about the pivots 122 in a second rotational direction 136. Accordingly, while the first and second engagement features are engaged, rotation of the fill tray 100 about the pivots 122 is blocked. As a result, as particulate material is poured/disposed on the end portion 132 of the fill tray 100, the base 128 and the side plates 102 of the fill tray 100 direct the particulate material to the hopper 94. Because the end portion 132 of the fill tray 100 is configured to receive the particulate material, equipment supporting the particulate material (e.g., forklift) may be positioned farther from the storage compartments of the air cart.

The pivots 122 and the slots 124 enable the fill tray 100 to move from the illustrated loading position (e.g., while the inlet assembly 101 is in the illustrated first loading configuration) to the transitional position, in which the first and second engagement features are disengaged and aligned with one another. As used herein with regard to the first and second engagement features, “align” refers to positions of the first and second engagement features that enable the first and second engagement features to engage in response to movement of the fill tray to the loading position. The pivots 122 and the slots 124 enable the fill tray 100 to move in a first direction 138 toward the transitional position, thereby disengaging the second engagement feature from the first engagement feature. When the fill tray 100 reaches the transitional position, the first and second engagement features are disengaged, thereby enabling the fill tray 100 to move (e.g., rotate about the pivots 122 in the first rotational direction 134) from the transitional position to the stowage position. While the fill tray is in the stowage position, the lateral extent (e.g., extent along the lateral axis 68) and the vertical extent (e.g., extent along the vertical axis 74) of the filling assembly may be reduced.

Furthermore, the pivots 122 and the slots 124 enable the fill tray 100 to move (e.g., rotate about the pivots 122 in the second rotational direction 136) from the stowage position to the transitional position, thereby aligning the first and second engagement features. In addition, the pivots 122 and the slots 124 enable the fill tray 100 to move in a second direction 140 from the transitional position to the illustrated loading position, thereby engaging the first and second engagement features. In the illustrated embodiment, each slot 124 has an arcuate shape configured to control the movement of the fill tray 100 from the loading position to the transitional position and from the transitional position to the loading position. However, in other embodiments, each slot may have any other suitable shape to control the movement of the fill tray.

As previously discussed, in the illustrated embodiment, the fill tray 100 has the slots 124, and the hopper 94 has the pivots 122. However, in other embodiments, the hopper may have at least one slot (e.g., all of the slots, a portion of the slots), and the fill tray may have at least one pivot (e.g., all of the pivots, a portion of the pivots). In such embodiments, all of the details and variations disclosed above with regard to the pivots and the slots apply to the slot(s) of the hopper and the pivot(s) of the fill tray.

In the illustrated embodiment, the fill tray 100 includes two handles 142 configured to enable an operator to move the fill tray between the loading, transitional, and stowage positions. Each handle 142 is coupled to one side plate 102 in the illustrated embodiment. However, in other embodiments, at least one handle may be coupled to the other side plate, to the base, or to any other suitable element(s) of the fill tray. Furthermore, each handle 142 may be coupled to the respective element(s) of the fill tray 100 by any suitable type(s) of connection(s), such as welded connection(s), adhesive connection(s), fastener connection(s), other suitable type(s) of connection(s), or a combination thereof. Furthermore, while the fill tray 100 includes two handles 142 in the illustrated embodiment, in other embodiments, the fill tray may include more or fewer handles (e.g., 1, 3, 4, or more). Furthermore, while the fill tray 100 includes handle(s) 142 in the illustrated embodiment, in other embodiments, the fill tray may include any other suitable device(s) (e.g., alone or in combination with the handle(s)) configured to facilitate movement of the fill tray (e.g., tab(s), protrusion(s), hydraulic cylinder(s), pneumatic cylinder(s), electric motor(s), etc.).

In the illustrated embodiment, each support 120 includes a respective first aperture 144, and the fill tray 100 (e.g., the ribs 126 of the fill tray 100) includes corresponding second apertures 146. Each first aperture 144 and each respective second aperture 146 are positioned to align with one another while the fill tray 100 is in the stowage position. Accordingly, a fastener may be disposed through at least one first aperture 144 and a respective second aperture 146 to block movement (e.g., translation and rotation) of the fill tray 100 relative to the hopper 94 while the fill tray is in the stowage position. As a result, movement of the fill tray 100 during operation of the air cart may be substantially reduced. While each support 120 includes a respective first aperture 144 and each rib 126 of the fill tray 100 includes a respective corresponding second aperture 146 in the illustrated embodiment, in other embodiments, the hopper and/or the fill tray may include fewer apertures (e.g., the hopper may include a single first aperture, and the fill tray may include a single second aperture). Furthermore, in certain embodiments, the first aperture(s) and/or the second aperture(s) may be omitted, and/or the inlet assembly may include one or more other suitable device(s) (e.g., latch(es), fastener(s), etc.) configured to selectively block rotation of the fill tray while the fill tray is in the stowage position.

In the illustrated embodiment, each side plate 102 of the fill tray 100 includes a respective recess 148. The recesses 148 are configured to receive a ledge 150 of the lid 96 while the fill tray 100 is in the loading position and the lid 96 is in an intermediate position between the open and closed positions. With the fill tray 100 in the loading position and the lid 96 in the intermediate position, the inlet assembly 101 is in a second loading configuration. With the lid in the intermediate position, the particulate material flows through a restricted area, which is established by the base 128 of the fill tray 100, the side plates 102 of the fill tray 100, and the lid 96, thereby reducing the flow rate of the particulate material into the hopper. While the fill tray 100 includes recesses 148 in the illustrated embodiment, in other embodiments, the recesses may be omitted.

In the illustrated embodiment, each side plate 102 of the fill tray 100 has an aperture 152 configured to receive a respective fastener to block rotation of the lid 96 toward the open position while the lid 96 is in the intermediate position. The fastener may include any suitable type of fastener (e.g., clip, pin, etc.) configured to contact the lid while the lid is in the intermediate position. While the fill tray 100 includes two apertures for blocking rotation of the lid 96 in the illustrated embodiment, in other embodiments, the fill tray may include more or fewer apertures (e.g., 0, 1, 3, 4, or more). For example, the apertures for blocking rotation of the lid may be omitted. In addition, the inlet assembly may include other suitable device(s) (e.g., alone or in combination with the aperture(s) and fastener(s)) configured to block rotation of the lid toward the open position while the lid is in the intermediate position, such as latch(es), magnet(s), other suitable device(s), or a combination thereof.

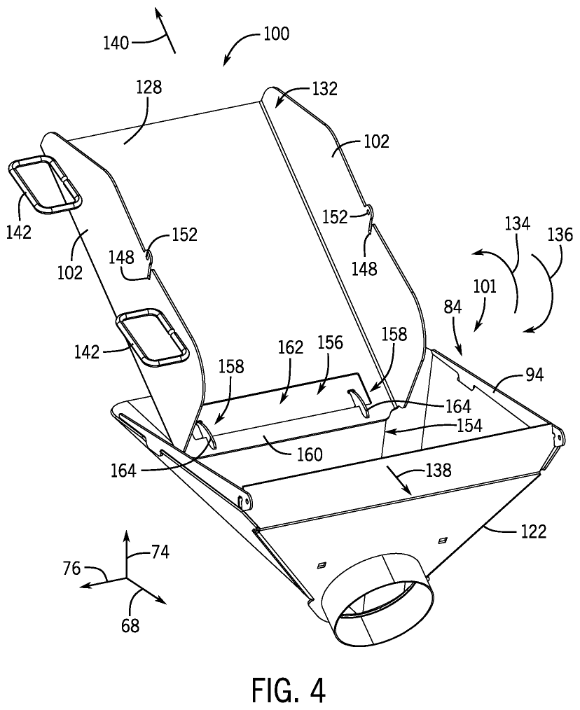

FIG. 4 is a perspective view of a portion of the inlet assembly 101 of FIG. 3. As previously discussed, the hopper 94 has a first engagement feature 154, and the fill tray 100 has a second engagement feature 156 configured to engage the first engagement feature 154 to block rotation of the fill tray 100 about the pivots. In the illustrated embodiment, the first engagement feature 154 includes two hooks 158, and the second engagement feature 156 includes a flat element 160, which is part of the base 128 of the fill tray 100. Each hook 158 is configured to engage the flat element 160 while the fill tray 100 is in the illustrated loading position, thereby blocking rotation of the fill tray 100 about the pivots in the first rotational direction 134. In addition, contact between the base 128 of the fill tray 100 (e.g., including the flat element 160 of the base 128) and the body 122 of the hopper 94 blocks rotation of the fill tray about the pivots in the second rotational direction 136. While the first engagement feature 154 includes two hooks 158 in the illustrated embodiment, in other embodiments, the first engagement feature may include more or fewer hooks (e.g., 1, 3, 4, 5, 6, or more).

In the illustrated embodiment, the base 128 of the fill tray 100 has an opening 162 configured to receive the hooks 158 while the fill tray is in the transitional position. For example, to transition the fill tray 100 from the stowage position to the illustrated loading position, the fill tray 100 is moved (e.g., rotated about the pivots in the second rotational direction 136) from the stowage position to the transitional position. The opening 162 enables the hooks 158 to pass through the base 128 of the fill tray 100 as the fill tray 100 approaches the transitional position. The fill tray 100 is then moved in the second direction 140 from the transitional position to the illustrated loading position, such that the hooks 158 engage the flat element 160 of the base 128 of the fill tray 100, thereby engaging the first and second engagement features, which blocks rotation of the fill tray 100 about the pivots in the first rotational direction 134. In addition, to transition the fill tray 100 from the illustrated loading position to the stowage position, the fill tray 100 is moved in the first direction 138 to the transitional position, in which the hooks 158 are disengaged from the flat element 160 of the base 128 of the fill tray 100. As a result, the hooks 158 are positioned within the opening 162. The fill tray 100 is then moved (e.g., rotated about the pivots in the first rotational direction 134) from the transitional position to the stowage position.

In the illustrated embodiment, each hook 158 has a curved engagement surface 164 configured to engage the flat element 160 during the transition from the stowage position to the transitional position. Accordingly, if the hooks 158 are not aligned with the opening 162 as the fill tray 100 approaches the transitional position, the curved engagement surfaces 164 may facilitate movement of the fill tray 100 toward the transitional position. While each hook 158 has a curved engagement surface 164 in the illustrated embodiment, in other embodiments, at least one hook may have an engagement surface with another suitable shape (e.g., angled, straight, etc.).

Furthermore, in the illustrated embodiment, each hook 158 is integrally formed with a respective support from a single sheet of material (e.g., steel, aluminum, polymeric material, composite material, etc.). Each single sheet of material may extend through a respective slot in the body of the hopper, thereby establishing the respective support and the respective hook. The single sheet of material may be coupled to the body of the hopper by any suitable type(s) of connection(s), such as a welded connection, an adhesive connection, a press-fit connection, a fastener connection, other suitable type(s) of connection(s), or a combination thereof. Forming each hook and the respective support from a single sheet of material may reduce the manufacturing cost of the inlet assembly. While each hook and each respective support are formed from a single sheet of material in the illustrated embodiment, in other embodiments, at least one hook and respective support(s) may be formed separately and separately coupled to the body of the hopper.

As previously discussed, in the illustrated embodiment, the first engagement feature 154 includes the hook(s) 158, and the second engagement feature 156 includes the flat element 160. However, in other embodiments, the first engagement feature may include any other suitable engagement device(s) (e.g., alone or in combination with the hook(s)), and/or the second engagement feature may include any other suitable engagement device(s) (e.g., alone or in combination with the flat element). For example, in certain embodiments, the first engagement feature may include a flat element, and the second engagement feature may include one or more hooks. Furthermore, in certain embodiments, one engagement feature may include protrusion(s), and the other engagement feature may include recess(es) configured to receive the protrusion(s). In addition, in certain embodiments, at least one engagement feature may include magnet(s).

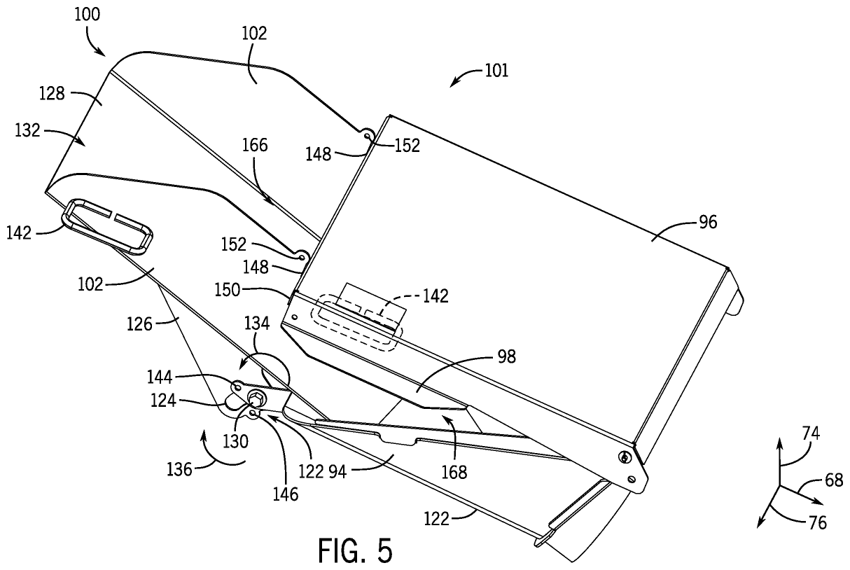

FIG. 5 is a perspective view of the inlet assembly 101 of FIG. 3, in which the inlet assembly 101 is in a second loading configuration. With the inlet assembly 101 in the illustrated second loading configuration, the fill tray 100 is in the loading position, and the lid 96 is in the intermediate position. Accordingly, the ledge 150 of the lid 96 is disposed within the recesses 148, thereby blocking rotation of the lid 96 from the illustrated intermediate position toward the closed position. With the lid 96 in the illustrated intermediate position, the particulate material flows through a restricted area 166, which is established by the base 128 of the fill tray 100, the side plates 102 of the fill tray 100, and the lid 96, thereby reducing the flow rate of the particulate material into the hopper. Because the longitudinal extent of the body 122 of the hopper 94 (e.g., extent of the body 122 of the hopper 94 along the longitudinal axis 76) is greater than the longitudinal distance between the side plates 102 (e.g., distance between the side plates 102 along the longitudinal axis 76), the particulate material may not flow through longitudinal gaps 168 in the inlet assembly 101. For example, the longitudinal extent of the hopper body 122 and/or the longitudinal distance between the side plates 102 may be particularly selected based on the maximum expected angle of repose of the particulate material to substantially reduce or eliminate particulate material flow through the longitudinal gaps 168 established by the fill tray 100, the hopper 94, and the lid 96.

As previously discussed, the aperture 152 of each side plate 102 is configured to receive a respective fastener to block rotation of the lid 96 toward the open position while the lid 96 is in the illustrated intermediate position. Accordingly, to transition the inlet assembly from the first loading configuration to the second loading configuration, the lid 96 may be rotated from the open position to the illustrated intermediate position, and one or more fasteners may be engaged with respective aperture(s) 152 to block rotation of the lid 96. In addition, to transition the inlet assembly from the second loading configuration to the first loading configuration, the fastener(s) may be disengaged from the respective aperture(s) 152, and the lid 96 may be rotated from the illustrated intermediate position to the open position.

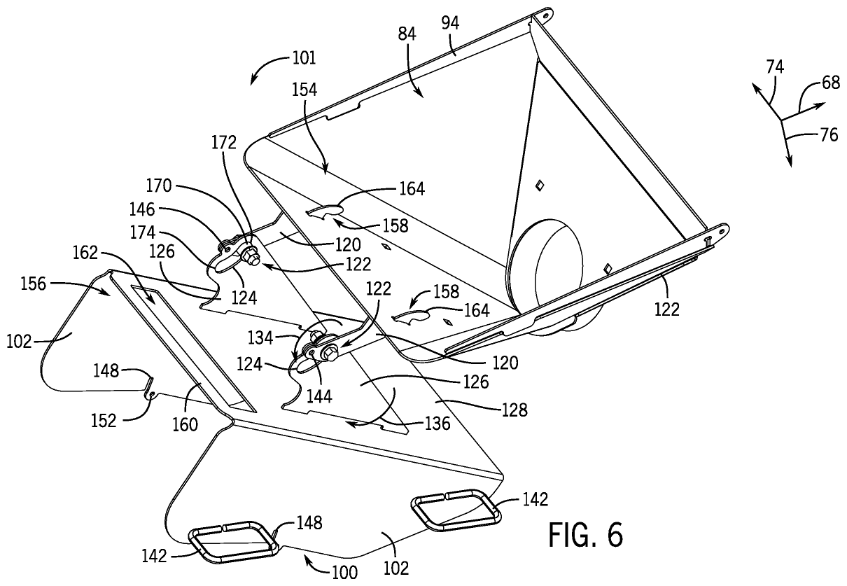

FIG. 6 is a perspective view of a portion of the inlet assembly 101 of FIG. 3, in which the inlet assembly 101 is in an operation configuration. With the inlet assembly 101 in the operation configuration, the fill tray 100 is in the illustrated stowage position, and the lid is in the closed position. As previously discussed, the pivots 122 and the slots 124 enable the fill tray 100 to move from the illustrated stowage position to the transitional position, in which the first and second engagement features are disengaged and aligned with one another. In addition, the pivots 122 and the slots 124 enable the fill tray 100 to move from the transitional position to the loading position, thereby engaging the first and second engagement features. In the illustrated embodiment, a bushing 170 is disposed between each pivot 122 and the respective slot 124. The bushings 170 are configured to facilitate translation and rotation of the fill tray 100 relative to the hopper 94, thereby facilitating the transition between fill tray positions. Each bushing may be formed from any suitable material(s), such as polymeric material(s), metal(s), etc. Furthermore, while a bushing 170 is disposed between each pivot 122 and the respective slot 124 in the illustrated embodiment, in other embodiments, at least one bushing may be omitted, and/or a bearing may be disposed between at least one pivot and the respective slot(s).

As previously discussed, to transition the fill tray 100 from the illustrated stowage position to the loading position, the fill tray 100 is moved (e.g., rotated about the pivots 122 in the second rotational direction 136 while each pivot 122 is positioned at a first end 172 of the respective slot 124) from the illustrated stowage position to the transitional position. The opening 162 enables the hooks 158 to pass through the base 128 of the fill tray 100 as the fill tray 100 approaches the transitional position. The fill tray 100 is then moved from the transitional position to the loading position (e.g., moved such that each pivot 122 is positioned at a second end 174 of the respective slot 124). As a result, the hooks 158 engage the flat element 160 of the base 128 of the fill tray 100, thereby engaging the first and second engagement features, which blocks rotation of the fill tray 100 about the pivots 122 in the first rotational direction 134. In addition, to transition the fill tray 100 from the loading position to the illustrated stowage position, the fill tray 100 is moved to the transitional position (e.g., moved such that each pivot 122 is positioned at the first end 172 of the respective slot 124), in which the hooks 158 are disengaged from the flat element 160 of the base 128 of the fill tray 100. As a result, the hooks 158 are positioned within the opening 162. The fill tray 100 is then moved (e.g., rotated about the pivots 122 in the first rotational direction 134 while each pivot 122 is positioned at the first end 172 of the respective slot 124) from the transitional position to the stowage position.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An inlet assembly for a filling assembly of a storage compartment assembly, comprising:
a hopper configured to receive particulate material; and
a fill tray movably coupled to the hopper and configured to move between a stowage position and a loading position;
wherein one of the fill tray or the hopper has a slot, the other of the fill tray or the hopper has a pivot engaged with the slot, the hopper has a first engagement feature, the fill tray has a second engagement feature configured to engage the first engagement feature to block rotation of the fill tray about the pivot, the pivot and the slot enable the fill tray to move from the stowage position to a transitional position to align the first and second engagement features, and the pivot and the slot enable the fill tray to move from the transitional position to the loading position to engage the first and second engagement features.

2. The inlet assembly of claim 1, wherein the first engagement feature comprises a hook, the second engagement feature comprises a flat element, and the hook is configured to engage the flat element while the fill tray is in the loading position.

3. The inlet assembly of claim 2, wherein the fill tray has an opening configured to receive the hook while the fill tray is in the transitional position.

4. The inlet assembly of claim 2, wherein the hopper comprises a support configured to support the fill tray, and the hook and the support are integrally formed from a single sheet of material.

5. The inlet assembly of claim 2, wherein the hook has a curved engagement surface configured to engage the flat element to facilitate movement of the fill tray toward the transitional position.

6. The inlet assembly of claim 1, wherein the slot has an arcuate shape.

7. The inlet assembly of claim 1, wherein the hopper has a first aperture, the fill tray has a second aperture, the first and second apertures are positioned to align with one another while the fill tray is in the stowage position, and the first and second apertures are configured to receive a fastener to block movement of the fill tray relative to the hopper.

8. The inlet assembly of claim 1, comprising a bushing disposed between the pivot and the slot to facilitate translation and rotation of the fill tray relative to the hopper.

9. The inlet assembly of claim 1, wherein the fill tray comprises a handle configured to facilitate movement of the fill tray between the stowage position and the loading position.

10. An inlet assembly for a filling assembly of a storage compartment assembly, comprising:
a hopper configured to receive particulate material;
a fill tray movably coupled to the hopper and configured to move between a stowage position and a loading position; and
a lid pivotally coupled to the hopper, wherein the lid is configured to pivot to an open position to enable the particulate material to enter the hopper, and the lid is configured to pivot to a closed position to block the particulate material from entering the hopper;
wherein one of the fill tray or the hopper has a slot, the other of the fill tray or the hopper has a pivot engaged with the slot, the hopper has a first engagement feature, the fill tray has a second engagement feature configured to engage the first engagement feature to block rotation of the fill tray about the pivot, the pivot and the slot enable the fill tray to move from the stowage position to a transitional position to align the first and second engagement features, and the pivot and the slot enable the fill tray to move from the transitional position to the loading position to engage the first and second engagement features.

11. The inlet assembly of claim 10, wherein the fill tray has a recess configured to receive a ledge of the lid while the fill tray is in the loading position and the lid is in an intermediate position between the open and closed positions.

12. The inlet assembly of claim 10, wherein the fill tray has an aperture configured to receive a fastener to block rotation of the lid toward the open position while the lid is in an intermediate position between the open and closed positions.

13. The inlet assembly of claim 10, wherein the first engagement feature comprises a hook, the second engagement feature comprises a flat element, and the hook is configured to engage the flat element while the fill tray is in the loading position.

14. The inlet assembly of claim 13, wherein the fill tray has an opening configured to receive the hook while the fill tray is in the transitional position.

15. The inlet assembly of claim 10, wherein the slot has an arcuate shape.

16. An auxiliary storage compartment assembly for an air cart, comprising:
a filling assembly configured to couple to an auxiliary storage compartment of the air cart, wherein the auxiliary storage compartment is configured to be positioned beneath a portion of a primary storage compartment of the air cart, the filling assembly has an inlet and an outlet, the outlet is configured to align with an opening in a lateral side of the auxiliary storage compartment, and the filling assembly is configured to establish a flow path that extends downwardly and laterally inwardly from the inlet to the outlet;
wherein the filling assembly comprises a fill chute, a fill tube, a hopper, and a fill tray movably coupled to the hopper, the fill tray is configured to move between a stowage position and a loading position, the fill chute is configured to couple to the lateral side of the auxiliary storage compartment, the outlet of the filling assembly is formed at the fill chute, the inlet of the filling assembly is formed at the hopper, and the fill tube is positioned between the hopper and the fill chute; and
wherein one of the fill tray or the hopper has a slot, the other of the fill tray or the hopper has a pivot engaged with the slot, the hopper has a first engagement feature, the fill tray has a second engagement feature configured to engage the first engagement feature to block rotation of the fill tray about the pivot, the pivot and the slot enable the fill tray to move from the stowage position to a transitional position to align the first and second engagement features, and the pivot and the slot enable the fill tray to move from the transitional position to the loading position to engage the first and second engagement features.

17. The auxiliary storage compartment assembly of claim 16, comprising a conveyor assembly comprising a rotary conveyor, wherein the rotary conveyor extends through a portion of the filling assembly and is configured to extend through a portion of the auxiliary storage compartment, and the rotary conveyor is configured to move particulate material laterally through the portion of the filling assembly and through the portion of the auxiliary storage compartment in response to rotation of the rotary conveyor.

18. The auxiliary storage compartment assembly of claim 16, wherein the first engagement feature comprises a hook, the second engagement feature comprises a flat element, and the hook is configured to engage the flat element while the fill tray is in the loading position.

19. The auxiliary storage compartment assembly of claim 18, wherein the fill tray has an opening configured to receive the hook while the fill tray is in the transitional position.

20. The auxiliary storage compartment assembly of claim 16, wherein the fill tray comprises a handle configured to facilitate movement of the fill tray between the stowage position and the loading position.
